(19) United States
(12) Patent Application Publication
(10) Pub. No.: US 2019/0294140 A1
(43) Pub. Date: Sep. 26, 2019

(54) WORK CONDITION VISUALIZATION APPARATUS

(71) Applicant: Mitsubishi Electric Corporation, Tokyo (JP)

(72) Inventors: Ken INUKAI, Tokyo (JP); Tatsuya KATO, Tokyo (JP)

(73) Assignee: Mitsubishi Electric Corporation, Tokyo (JP)

(21) Appl. No.: 16/342,537

(22) PCT Filed: Nov. 16, 2016
(86) PCT No.: PCT/JP2016/083963

§ 371 Date: Apr. 17, 2019

(51) Int. Cl. G05B 19/409; G06Q 50/04; G06Q 10/10; G05B 19/402; G05B 19/4155; G05B 19/418; G05B 19/4063

(52) U.S. Cl. CPC G05B 19/409; G06Q 50/04; G06Q 10/109; G05B 19/4063; G05B 19/4155; G05B 19/41865; G05B 19/41835; G05B 19/402

(57) ABSTRACT

A work condition visualization apparatus includes an input unit that accepts an input of an instruction to specify whether to operate a machine in manual operation work or in accordance with a program, and an output unit that outputs time information on the manual operation work and time information on the program on the basis of an instruction accepted by the input unit.

### FIELD

The present invention relates to a work condition visualization apparatus that notifies a condition of operation of a machine.

### BACKGROUND

A machine is used when machining a workpiece. The machine operates in accordance with a program and machines the workpiece. An apparatus that notifies a condition in which a machine operates in accordance with a program has been proposed (see, for example, Patent Literature 1). With the apparatus, a manager of the machine can know the condition of operation of the machine.

### CITATION LIST

### Patent Literature

Patent Literature 1: Japanese Patent Application Laid-open No. 2004-265034

### SUMMARY

### Technical Problem

As mentioned above, the machine operates in accordance with the program to machine the workpiece, but a worker performs work of manually operating the machine before and/or after the machine operates in accordance with the program. For example, the manual operation work is work of adjusting a position of the machine relative to the workpiece before machining in order to properly machine the workpiece. In the manual operation work, the worker operates the machine irrespective of the program in order to adjust the position of the machine relative to the workpiece, for example.

The above-described conventional apparatus notifies a condition in which the machine operates in accordance with the program, but does not notify a condition in which the machine operates in the manual operation work. That is, with the above-described conventional apparatus, the manager of the machine cannot know the condition in which the machine operates in accordance with work of the worker.

The present invention has been made in view of the above, and an object thereof is to provide a work condition visualization apparatus with which a manager of a machine can know a condition in which the machine operates in accordance with a program and a condition in which the machine operates in manual operation work.

### Solution to Problem

To solve the above problems and achieve the object, the present invention includes an input unit that accepts an input of an instruction to specify whether to operate a machine in manual operation work or in accordance with a program, and an output unit that outputs time information on the manual operation work and time information on the program on a basis of an instruction accepted by the input unit.

### Advantageous Effects of Invention

The work condition visualization apparatus according to the present invention achieves an effect that a manager of a machine can know a condition in which the machine operates in accordance with a program and a condition in which the machine operates in manual operation work.

### BRIEF DESCRIPTION OF DRAWINGS

FIG. 1 is a diagram illustrating a configuration of a work condition visualization apparatus according to an embodiment.

FIG. 2 is a diagram illustrating a screen of an input unit of the work condition visualization apparatus in the embodiment.

FIG. 3 is a diagram illustrating an example of a screen for setting specific contents of positioning work in the embodiment.

FIG. 4 is a diagram illustrating a processing circuit in a case where at least a part of constituent elements constituting the input unit, a determination unit, a management unit, and an output unit included in the work condition visualization apparatus in the embodiment is realized by the processing circuit.

FIG. 5 is a diagram illustrating a processor in a case where at least a part of functions of the input unit, the determination unit, the management unit, and the output unit included in the work condition visualization apparatus in the embodiment is realized by the processor.

FIG. 6 is a flowchart illustrating a procedure in a first operation of the work condition visualization apparatus according to the embodiment.

FIG. 7 is a flowchart illustrating a procedure in a second operation of the work condition visualization apparatus according to the embodiment.

FIG. 8 is a diagram illustrating an example of data displayed by the output unit of the work condition visualization apparatus according to the embodiment.

FIG. 9 is a diagram for explaining an effect achieved by the work condition visualization apparatus in the embodiment.

### DESCRIPTION OF EMBODIMENTS

Hereinafter, a work condition visualization apparatus according to an embodiment of the present invention will be described in detail with reference to the drawings. The invention is not limited to the embodiment.

### Embodiment

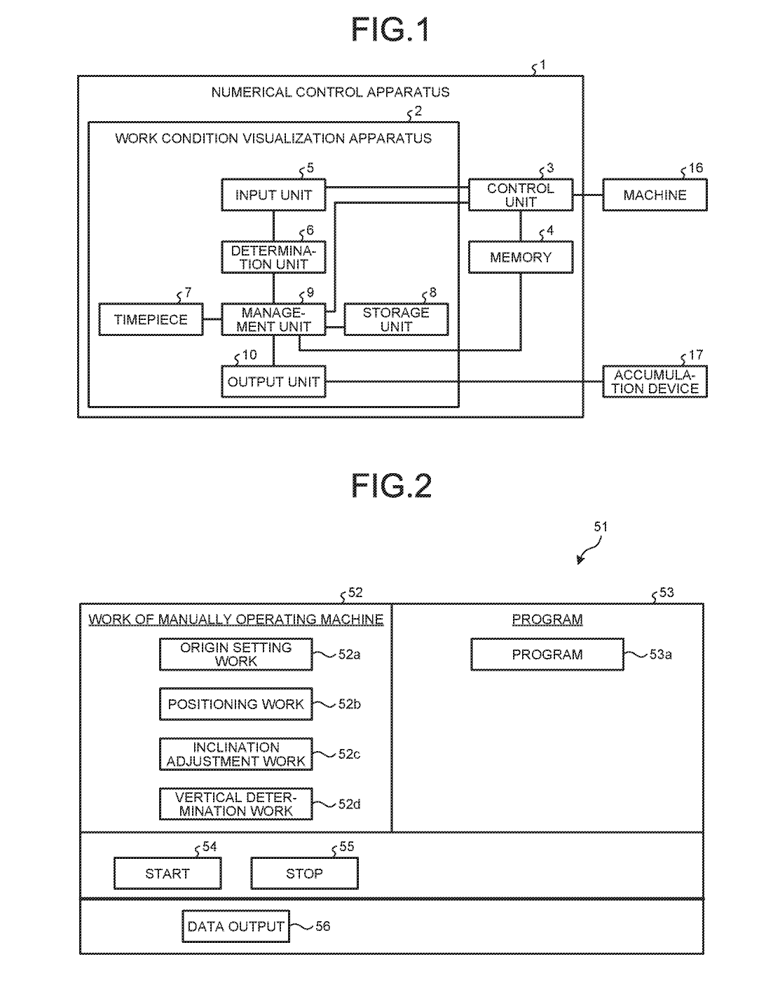

First, a configuration of a work condition visualization apparatus 2 according to an embodiment will be described. FIG. 1 is a diagram illustrating the configuration of the work condition visualization apparatus 2 according to the embodiment. The work condition visualization apparatus 2 is an apparatus that notifies a condition in which a machine 16 operates in accordance with a program and a condition in which the machine 16 operates in manual operation work. FIG. 1 also illustrates the machine 16. An example of the machine 16 is a wire electric discharge machining machine. Work of manually operating the machine 16 is work performed by a worker before and/or after the machine 16 operates in accordance with the program. A specific example of the work of manually operating the machine 16 is work of adjusting a position of the machine 16 relative to a workpiece in order to properly machine the workpiece. In the work of manually operating the machine 16, the worker operates the machine 16 irrespective of the program in order to adjust the position of the machine 16 relative to the workpiece, for example.

As illustrated in FIG. 1, the work condition visualization apparatus 2 is included in a numerical control apparatus 1 that controls the machine 16 that machines a workpiece. The numerical control apparatus 1 includes the work condition visualization apparatus 2, and further includes a control unit 3 that controls the machine 16 in accordance with a program for machining a workpiece, and a memory 4 that stores the program. Since the control unit 3 controls the machine 16 in accordance with the program stored in the memory 4, the machine 16 operates in accordance with the program.

The work condition visualization apparatus 2 includes an input unit 5 that accepts an input of an instruction to specify whether to operate the machine 16 in the manual operation work or in accordance with the program. In a case where the input unit 5 accepts an input of an instruction to specify that the machine 16 is to be operated in the manual operation work, the input unit 5 accepts the input of the instruction to specify that the machine 16 is to be operated in the manual operation work with respect to any of multiple work items.

In the embodiment, the input unit 5 is a touch panel display. FIG. 2 is a diagram illustrating a screen 51 of the input unit 5 of the work condition visualization apparatus 2 in the embodiment. As illustrated in FIG. 2, the screen 51 of the input unit 5 includes a work instruction input accepting area 52, which is an area that accepts an input of a work instruction that is an instruction to operate the machine 16 in the manual operation work, and a program instruction input accepting area 53, which is an area that accepts an input of a program instruction that is an instruction to operate the machine 16 in accordance with the program.

The work instruction input accepting area 52 includes four work item buttons 52a to 52d. The four work items are examples of the multiple work items. Work corresponding to each of the four work items is an example of the work of manually operating the machine 16. In the embodiment, the contents of the four work items are origin setting work, positioning work, inclination adjustment work, and vertical determination work. The origin setting work is work of setting a coordinate origin of a workpiece, and the positioning work is work of arranging the workpiece at an appropriate position on a horizontal plane. The inclination adjustment work is work of adjusting the inclination of the workpiece relative to the horizontal plane, and the vertical determination work is work of arranging a wire electrode which is one component constituting the machine 16 in a vertical direction.

In each of the fields of the work item buttons 52a to 52d, character strings of “origin setting work”, “positioning work”, “inclination adjustment work” or “vertical determination work” is displayed. As can be understood from the character strings, each of the work item buttons 52a, 52b, 52c, and 52d is a button for accepting an input of an instruction of the above-described origin setting work, positioning work, inclination adjustment work, or vertical determination work.

The program instruction input accepting area 53 includes a button 53a for accepting an input of a program instruction which is an instruction to operate the machine 16 in accordance with the program. A character string “program” is described in a field for specifying the button 53a. As illustrated in FIG. 2, the screen 51 of the input unit 5 further includes a button 54 for accepting an input of an instruction to start an operation of the machine 16 and a button 55 for accepting an input of an instruction to end the operation of the machine 16. A character string “start” is displayed in a field for specifying the button 54, and a character string “stop” is displayed in a field for specifying the button 55.

When operating the machine 16 in the manual operation work, the worker presses any one of the four work item buttons 52a to 52d included in the work instruction input accepting area 52 on the screen 51 of the input unit 5, and then presses the button 54 for accepting an input of an instruction to start the operation of the machine 16. For example, when the worker operates the machine 16 in the positioning work in the manual operation work, the worker presses the button 52b corresponding to the positioning work among the four work item buttons 52a to 52d included in the work instruction input accepting area 52, and then presses the button 54.

When any one of the buttons included in the screen 51 is pressed, the input unit 5 accepts an instruction corresponding to the pressed button. That is, when any one of the buttons 52a to 52d and the button 54 are pressed, the input unit 5 accepts an input of a work instruction to operate the machine 16 in the manual operation work.

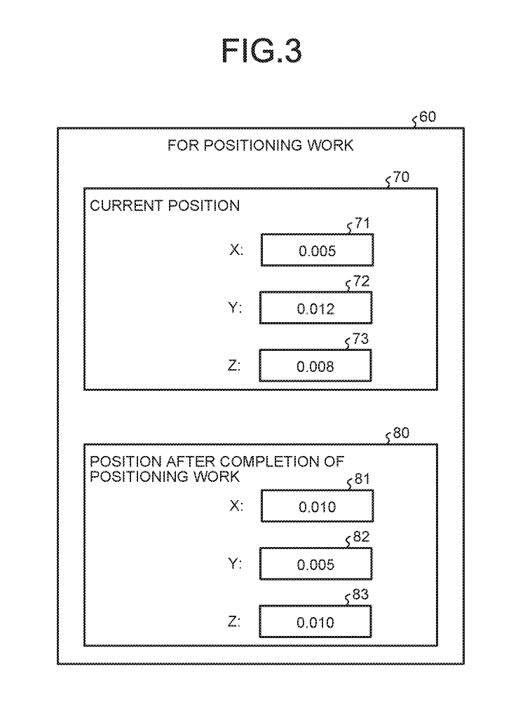

For example, when the button 52b, in which the character string “positioning work” is described, is pressed and then the button 54 for accepting an input of an instruction to start the operation of the machine 16 is pressed, the input unit 5 accepts an instruction to operate the machine 16 in the positioning work, which is manual operation work. When the button 52b is pressed, the input unit 5 displays a screen for setting specific contents of the positioning work on the touch panel display. FIG. 3 is a diagram illustrating an example of a screen 60 for setting specific contents of the positioning work in the embodiment.

On the screen 60 for setting specific contents of the positioning work, a character string “for positioning work” indicating that the screen 60 is a screen for setting specific contents of the positioning work is displayed. The screen 60 includes a first area 70 that is an area displaying information on a current position of a workpiece and a second area 80 that is an area displaying information on a position of the workpiece after completion of the positioning work. In the first area 70, a character string “current position” indicating that the first area 70 is an area displaying information on the current position of the workpiece is displayed, and in the second area 80, a character string “position after completion of positioning work” indicating that the second area 80 is an area displaying information on the position of the workpiece after completion of the positioning work is displayed.

The first area 70 includes an area 71 for displaying a current position of the workpiece in an X direction, an area 72 for displaying a current position of the workpiece in a Y direction, and an area 73 for displaying a current position of the workpiece in a Z direction. The second area 80 includes an area 81 for setting a position of the workpiece in the X direction after completion of the positioning work, an area 82 for setting a position of the workpiece in the Y direction after completion of the positioning work, and an area 83 for setting a position of the workpiece in the Z direction after completion of the positioning work.

The worker confirms numerical values displayed in the area 71, the area 72, and the area 73, and inputs numerical values corresponding to positions of the workpiece in the X direction, the Y direction, and the Z direction after completion of the positioning work to the area 81, the area 82, and the area 83. For example, the worker inputs the numerical values to the area 81, the area 82, and the area 83 by using an input unit connected to a display device that displays the screen 60. The input unit is not illustrated. After inputting the numerical values to the area 81, the area 82, and the area 83 of the screen 60, the worker presses the button 54 for accepting an input of an instruction to start the operation of the machine 16. The control unit 3 causes the machine 16 to perform an operation for moving the workpiece to a position corresponding to the numerical values input to the area 81, the area 82, and the area 83 in accordance with the instruction of the positioning work.

When the worker intends to end the operation of the machine 16 after the machine 16 starts operating in the manual operation work, the worker may press the button 55 for accepting an input of an instruction to end the operation of the machine 16 on the screen 51.

When operating the machine 16 in accordance with the program, the worker presses the button 53a included in the program instruction input accepting area 53 on the screen 51 of the input unit 5. Thereafter, the worker presses the button 54 for accepting an input of an instruction to start the operation of the machine 16. As described above, when any one of the buttons included in the screen 51 is pressed, the input unit 5 accepts an instruction corresponding to the pressed button. That is, when the button 53a and the button 54 are pressed, the input unit 5 accepts an input of a program instruction to operate the machine 16 in accordance with the program.

The screen 51 of the input unit 5 further includes a button 56 for accepting an input of an instruction to output data on the operation of the machine 16. In a field for specifying the button 56 in FIG. 2, a character string “data output” is displayed. The data on the operation of the machine 16 is data based on time at which each of the above-described four work item buttons 52a to 52d, the button 53a for accepting an input of a program instruction to operate the machine 16 in accordance with the program, the button 54 for accepting an input of an instruction to start the operation of the machine 16, and the button 55 for accepting an input of an instruction to end the operation of the machine 16 is pressed, and the data on the operation of the machine 16 includes first data and second data. The first data and the second data will be described later.

In a case where the input unit 5 accepts an input of a work instruction which is an instruction to operate the machine 16 in the manual operation work, the control unit 3 operates the machine 16 in accordance with the work instruction. For example, in a case where the button 52b for accepting an input of an instruction of the positioning work is pressed and thereafter the button 54 for accepting an input of an instruction to start the operation of the machine 16 is pressed, the control unit 3 operates the machine 16 in accordance with the instruction of the positioning work. In a case where the button 55 for accepting an input of an instruction to end the operation of the machine 16 is pressed when the machine 16 is operating in accordance with the instruction of the positioning work, the control unit 3 ends the operation of the machine 16.

In a case where the input unit 5 accepts an input of a program instruction that is an instruction to operate the machine 16 in accordance with the program, the control unit 3 controls the machine 16 in accordance with the program stored in the memory 4, and the machine 16 operates in accordance with the program.

The work condition visualization apparatus 2 further includes a determination unit 6 that determines whether the machine 16 operates in the manual operation work or operates in accordance with the program, on the basis of an instruction accepted by the input unit 5. Specifically, when the instruction accepted by the input unit 5 is a work instruction, the determination unit 6 determines that the machine 16 operates in the manual operation work. More specifically, when any one of the four work item buttons 52a to 52d is pressed, the determination unit 6 determines that the machine 16 operates in work corresponding to the pressed button in the manual operation work. When the instruction accepted by the input unit 5 is a program instruction, the determination unit 6 determines that the machine 16 operates in accordance with the program.

The work condition visualization apparatus 2 further includes a timepiece 7 and a storage unit 8 that stores information. The work condition visualization apparatus 2 further includes a management unit 9 that stores, in the storage unit 8, information on time when the machine 16 operated in the manual operation work and information on time when the machine 16 operated in accordance with the program on the basis of determination performed by the determination unit 6. When storing information in the storage unit 8, the management unit 9 uses time indicated by the timepiece 7 to specify the time when the machine 16 operated in the manual operation work and the time when the machine 16 operated in accordance with the program, and the management unit 9 stores the information on the specified time in the storage unit 8.

More specifically, when storing the information on the time when the machine 16 operated in the manual operation work in the storage unit 8, the management unit 9 uses the time indicated by the timepiece 7 to specify the time when the machine 16 operated, and the management unit 9 stores the information on the specified time in the storage unit 8, for each of the multiple work items. The management unit 9 may specify the time when the machine 16 operated by specifying each of start time and end time of the operation of the control unit 3 on the basis of the time indicated by the timepiece 7. In a case where the determination unit 6 determines that the machine 16 operated in accordance with the program, the management unit 9 may specify the time when the machine 16 operated in accordance with the program on the basis of the program stored in the memory 4, and may store the specified information in the storage unit 8.

In any case, the storage unit 8 stores the information on the time when the machine 16 operated in the manual operation work and the information on the time when the machine 16 operated in accordance with the program on the basis of the determination made by the determination unit 6. More specifically, when storing the information on the time when the machine 16 operated in the manual operation work in the storage unit 8, the storage unit 8 stores information on the time when the machine 16 operated in the storage unit 8, for each of the multiple work items.

In addition, the time when the machine 16 operated is specified by the time when the machine 16 started the operation and the time when the machine 16 ended the operation. Therefore, when storing the information on the time when the machine 16 operated in the manual operation work in the storage unit 8, the management unit 9 stores, in the storage unit 8, information on the time when the machine 16 started the operation in the manual operation work, and information on the time when the machine 16 ended the operation. More specifically, the management unit 9 stores, in the storage unit 8, the information on the time when the machine 16 started the operation in the manual operation work and the information on the time when the machine 16 ended the operation, for each of the multiple work items. When storing the information on the time when the machine 16 operated in accordance with the program in the storage unit 8, the management unit 9 stores, in the storage unit 8, the information on the time when the machine 16 started the operation in accordance with the program and the information on the time when the machine 16 ended the operation.

On the basis of the determination performed by the determination unit 6, the storage unit 8 stores the information on the time when the machine 16 started the operation in the manual operation work and the information on the time when the machine 16 ended the operation. More specifically, on the basis of the determination performed by the determination unit 6, the storage unit 8 stores the information on the time when the machine 16 started the operation in the manual operation work and the information on the time when the machine 16 ended the operation, for each of the multiple work items. On the basis of the determination performed by the determination unit 6, the storage unit 8 stores the information on the time when the machine 16 started the operation in accordance with the program and the information on the time when the machine 16 ended the operation.

The work condition visualization apparatus 2 further includes an output unit 10 that, when the input unit 5 accepts an input of an instruction to output data on the operation of the machine 16 by the button 56 on the screen 51 of the input unit 5 being pressed, outputs time information on the manual operation work and time information on the program on the basis of the instruction accepted by the input unit 5. In the embodiment, the output unit 10 outputs both of the first data and the second data on the operation of the machine 16. In the embodiment, the output unit 10 is a touch panel display that realizes the function of the input unit 5. That is, in the embodiment, one touch panel display realizes the function of the output unit 10 and the function of the input unit 5.

The first data is data for determining a condition in which the machine 16 operates in the manual operation work and a condition in which the machine 16 operates in accordance with the program depending on passage of time. The second data is data for specifying the total period of time for which the machine 16 operates in the manual operation work and the total period of time for which the machine 16 operates in accordance with the program. More specifically, the first data is data for determining a condition in which the machine 16 operates in the manual operation work and a condition in which the machine 16 operates in accordance with the program depending on passage of time, for each of the multiple work items. The second data is data for specifying the total period of time for which the machine 16 operates in the manual operation work and the total period of time for which the machine 16 operates in accordance with the program, for each of the multiple work items.

Specifically, when the button 56 on which the character string “data output” is displayed is pressed on the screen 51 of the input unit 5 illustrated in FIG. 2, the management unit 9 supplies both of the first data and the second data to the output unit 10 on the basis of the information stored in the storage unit 8. The output unit 10 outputs both of the first data and the second data supplied from the management unit 9. That is, the output unit 10 displays both of the first data and the second data on the basis of the information stored in the storage unit 8. In the embodiment, since the output unit 10 is a touch panel display, the output unit 10 displays both of the first data and the second data.

The output unit 10 also has a function of transmitting both of the first data and the second data to an accumulation device 17 outside the work condition visualization apparatus 2. FIG. 1 also illustrates the accumulation device 17. The accumulation device 17 is a device that accumulates data transmitted from the output unit 10 and permits access from an apparatus different from the work condition visualization apparatus 2.

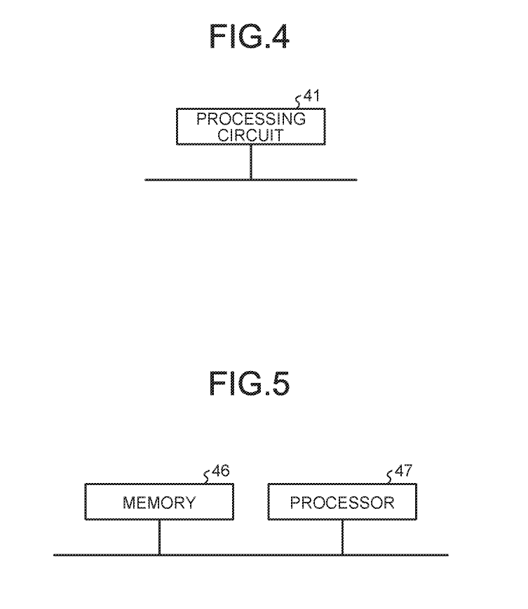

FIG. 4 is a diagram illustrating a processing circuit 41 in a case where at least a part of constituent elements constituting the input unit 5, the determination unit 6, the management unit 9, and the output unit 10 included in the work condition visualization apparatus 2 in the embodiment is realized by the processing circuit 41. That is, at least a part of the functions of the input unit 5, the determination unit 6, the management unit 9, and the output unit 10 may be realized by the processing circuit 41.

The processing circuit 41 is dedicated hardware. That is, the processing circuit 41 is, for example, a single circuit, a composite circuit, a programmed processor, a parallel programmed processor, an application specific integrated circuit (ASIC), a field-programmable gate array (FPGA), or a combination thereof. A part of the input unit 5, the determination unit 6, the management unit 9, and the output unit 10 may be dedicated hardware separate from the remainder thereof.

FIG. 5 is a diagram illustrating a processor 47 in a case where at least a part of the functions of the input unit 5, the determination unit 6, the management unit 9, and the output unit 10 included in the work condition visualization apparatus 2 in the embodiment is realized by the processor 47. That is, at least a part of the functions of the input unit 5, the determination unit 6, the management unit 9, and the output unit 10 may be realized by the processor 47 executing a program stored in a memory 46. The processor 47 is a central processing unit (CPU), a processing device, an arithmetic device, a microprocessor, a microcomputer, or a digital signal processor (DSP). FIG. 5 also illustrates the memory 46.

In the case where at least a part of the functions of the input unit 5, the determination unit 6, the management unit 9, and the output unit 10 is realized by the processor 47, the part of the functions is realized by a combination of the processor 47 and software, firmware, or software and firmware. The software or the firmware is described as a program and stored in the memory 46. By reading and executing the program stored in the memory 46, the processor 47 realizes at least a part of the functions of the input unit 5, the determination unit 6, the management unit 9, and the output unit 10.

That is, when at least a part of the functions of the input unit 5, the determination unit 6, the management unit 9, and the output unit 10 is realized by the processor 47, the work condition visualization apparatus 2 includes the memory 46 for storing a program with which a step is executed as a result, the step being executed by a part of the input unit 5, the determination unit 6, the management unit 9, and the output unit 10. It can be said that the program stored in the memory 46 causes a computer to execute a procedure or method executed by a part of the input unit 5, the determination unit 6, the management unit 9, and the output unit 10.

The memory 46 is, for example, a non-volatile or volatile semiconductor memory such as a random access memory (RAM), a read only memory (ROM), a flash memory, an erasable programmable read only memory (EPROM), or an electrically erasable programmable read only memory (EEPROM); a magnetic disk; a flexible disk; an optical disk; a compact disc; a mini disk; a digital versatile disk (DVD); or the like.

Regarding a plurality of functions of the input unit 5, the determination unit 6, the management unit 9, and the output unit 10, a part of the functions may be realized by dedicated hardware and the remainder of the functions may be realized by software or firmware. Thus, the functions of the input unit 5, the determination unit 6, the management unit 9, and the output unit 10 can be realized by hardware, software, firmware, or a combination thereof.

Next, an operation of the work condition visualization apparatus 2 according to the embodiment will be described. The operation of the work condition visualization apparatus 2 includes a first operation and a second operation. The first operation is an operation from when the input unit 5 accepts an input of an instruction to when the storage unit 8 stores information. The second operation is an operation performed by the output unit 10 of outputting data on the operation of the machine 16 on the basis of the information stored in the storage unit 8. The first operation and the second operation will be sequentially described.

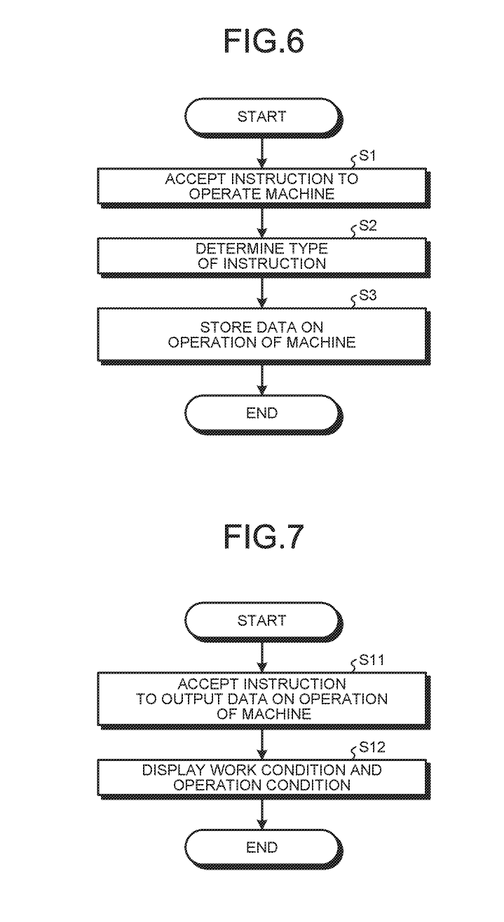

FIG. 6 is a flowchart illustrating a procedure in the first operation of the work condition visualization apparatus 2 according to the embodiment. First, the input unit 5 accepts an input of an instruction to operate the machine 16 (S1). The instruction accepted by the input unit 5 is either an instruction to operate the machine 16 in the manual operation work or an instruction to operate the machine 16 in accordance with the program. On the basis of the instruction accepted by the input unit 5, the determination unit 6 determines whether the machine 16 operates in the manual operation work or in accordance with the program (S2). That is, the determination unit 6 determines the type of the instruction accepted by the input unit 5 (S2).

On the basis of the determination performed by the determination unit 6, the management unit 9 stores the information on the time when the machine 16 operated in the manual operation work and the information on the time when the machine 16 operated in accordance with the program in the storage unit 8. That is, the storage unit 8 stores the information on the time when the machine 16 operated in the manual operation work and the information on the time when the machine 16 operated in accordance with the program (S3). In Step S3 of FIG. 6, the information on the time when the machine 16 operated in the manual operation work and the information on the time when the machine 16 operated in accordance with the program are displayed as “data on operation of machine”.

Each of the operations from Step S1 to Step S3 described above is performed each time the input unit 5 accepts an input of an instruction to operate the machine 16.

FIG. 7 is a flowchart illustrating a procedure in the second operation of the work condition visualization apparatus 2 according to the embodiment. First, the input unit 5 accepts an input of an instruction to output data on the operation of the machine 16 (S11). The output unit 10 displays both of the first data and the second data on the operation of the machine 16 (S12). That is, the output unit 10 displays a work condition which is a condition in which the machine 16 operated in accordance with an instruction of the worker, and an operation condition which is a condition in which the machine 16 operated in accordance with the program (S12).

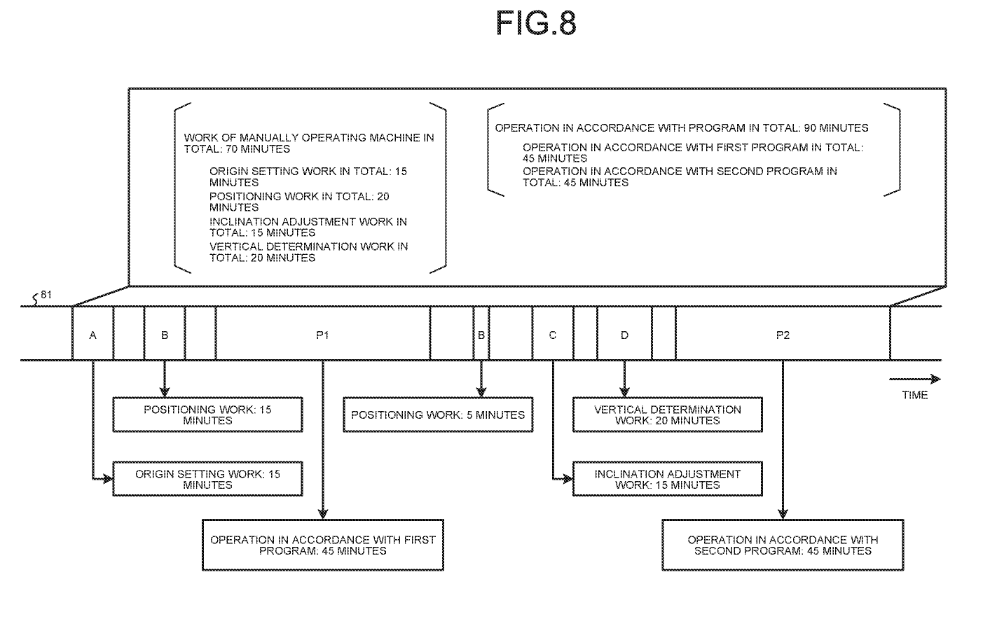

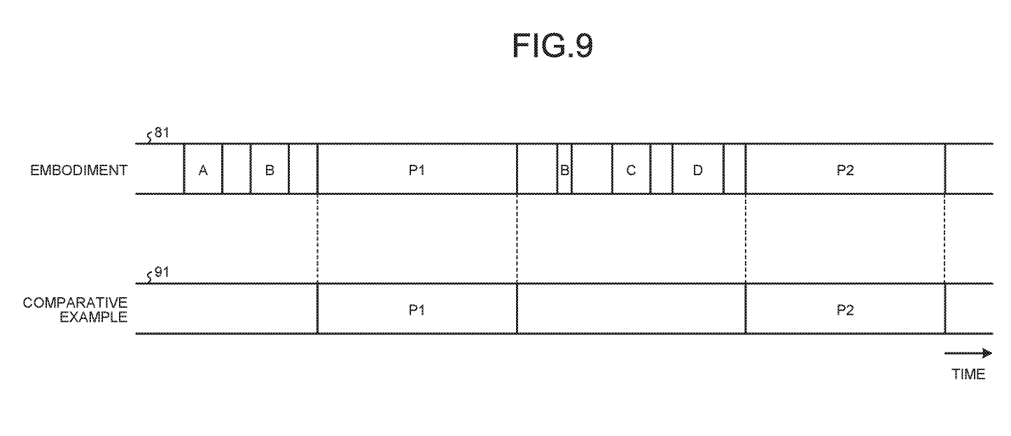

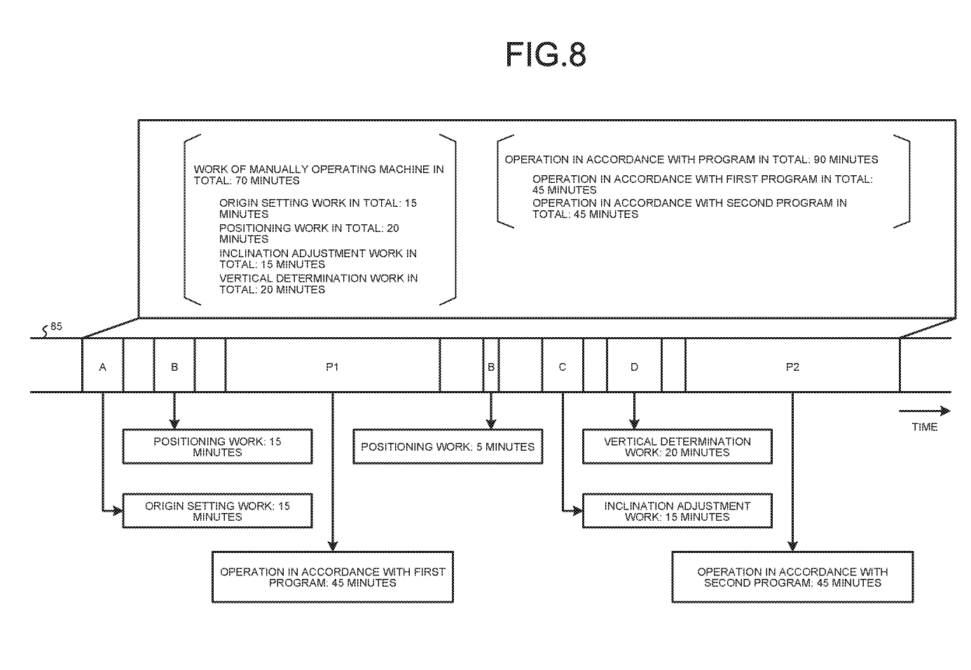

FIG. 8 is a diagram illustrating an example of data displayed by the output unit 10 of the work condition visualization apparatus 2 according to the embodiment. The following items are assumed. That is, it is assumed that first the machine 16 operated in work corresponding to a work item A, second the machine 16 operated in work corresponding to a first work item B, third the machine 16 operated in accordance with a first program P1, fourth the machine 16 operated in work corresponding to a second work item B, fifth the machine 16 operated in work corresponding to a work item C, sixth the machine 16 operated in work corresponding to a work item D, and last the machine 16 operated in accordance with a second program P2. The work corresponding to each of the work item A, the work item B, the work item C, and the work item D is work of manually operating the machine 16.

With a band 81 including seven blocks “A”, “B”, “P1”, “B”, “C”, “D”, and “P2” of FIG. 8, the output unit 10 displays the first data for determining the condition in which the machine 16 operates in the manual operation work and the condition in which the machine 16 operates in accordance with the program depending on passage of time.

In the band 81 of FIG. 8, the block A corresponds to the work item A, the block B corresponds to the work item B, the block C corresponds to the work item C, and the block D corresponds to the work item D. The block P1 corresponds to the first program P1 and the block P2 corresponds to the second program P2. The work item A corresponds to the origin setting work, the work item B corresponds to the positioning work, the work item C corresponds to the inclination adjustment work, and the work item D corresponds to the vertical determination work.

That is, the output unit 10 displays the first data by the band 81, the first data indicating the following condition in which first the machine 16 operated in work corresponding to the work item A, second the machine 16 operated in work corresponding to the work item B, third the machine 16 operated in accordance with the program P1, fourth the machine 16 operated in work corresponding to the work item B, fifth the machine 16 operated in work corresponding to the work item C, sixth the machine 16 operated in work corresponding to the work item D, and last the machine 16 operated in accordance with the second program P2.

The following items are further assumed. That is, a period of time for which the machine 16 operated in the origin setting work corresponding to the work item A is “15 minutes”. A period of time for which the machine 16 operated in the positioning work corresponding to the first work item B is “15 minutes”. A period of time for which the machine 16 operated in accordance with the first program P1 is “45 minutes”. A period of time for which the machine 16 operated in the positioning work corresponding to the second work item B is “5 minutes”. A period of time for which the machine 16 operated in the inclination adjustment work corresponding to the work item C is “15 minutes”. A period of time for which the machine 16 operated in the vertical determination work corresponding to the work item D is “20 minutes”. A period of time for which the machine 16 operated in accordance with the second program P2 is “45 minutes”. That is, the total period of time for which the machine 16 operated in the positioning work corresponding to the work item B is “20 minutes”, the total period of time for which the machine 16 operated in the manual operation work is “70 minutes”, and the total period of time for which the machine 16 operated in accordance with the program is “90 minutes”.

The output unit 10 displays, in an area above the band 81 on the screen including the band 81, information indicating that the total period of time for which the machine 16 operated in the manual operation work is “70 minutes”, and the total period of time for which the machine 16 operated in accordance with the program is “90 minutes”. Specifically, the output unit 10 displays, in the area above the band 81 on the screen including the band 81, information indicating that the total period of time for which the machine 16 operated in the origin setting work is “15 minutes”, the total period of time for which the machine 16 operated in the positioning work is “20 minutes”, the total period of time for which the machine 16 operated in the inclination adjustment work is “15 minutes”, and the total period of time for which the machine 16 operated in the vertical determination work is “20 minutes”.

In addition, the output unit 10 displays, in the area above the band 81 on the screen including the band 81, information indicating that the total period of time for which the machine 16 operated in accordance with the first program P1 is “45 minutes”, and the total period of time for which the machine 16 operated in accordance with the second program P2 is “45 minutes”. “Operation” described in FIG. 8 means the operation of the machine 16.

The output unit 10 displays, in an area below the band 81 on the screen including the band 81, that the period of time for which the machine 16 operated in the origin setting work corresponding to the work item A is “15 minutes”, the period of time for which the machine 16 operated in the positioning work corresponding to the first work item B is “15 minutes”, and the period of time for which the machine 16 operated in accordance with the first program P1 is “45 minutes”. In addition, the output unit 10 displays, in the area below the band 81 on the screen including the band 81, information indicating that the period of time for which the machine 16 operated in the positioning work corresponding to the second work item B is “5 minutes”, the period of time for which the machine 16 operated in the inclination adjustment work corresponding to the work item C is “15 minutes”, the period of time for which the machine 16 operated in the vertical determination work corresponding to the work item D is “20 minutes”, and the period of time for which the machine 16 operated in accordance with the second program P2 is “45 minutes”.

That is, the output unit 10 displays, together with the first data, the second data for specifying the total period of time for which the machine 16 operates in the manual operation work and the total period of time for which the machine 16 operates in accordance with the program.

The output unit 10 displays the first data and the second data, and transmits both of the first data and the second data to the accumulation device 17 outside the work condition visualization apparatus 2.

As described above, the input unit 5 accepts an input of an instruction to specify whether to operate the machine 16 in the manual operation work or in accordance with the program. On the basis of the instruction accepted by the input unit 5, the output unit 10 displays both of the first data for determining a condition in which the machine 16 operates in the manual operation work and a condition in which the machine 16 operates in accordance with the program depending on passage of time, and the second data for specifying the total period of time for which the machine 16 operates in the manual operation work and the total period of time for which the machine 16 operates in accordance with the program. That is, the input unit 5 accepts an input of an instruction to operate the machine 16, and the output unit 10 displays data for specifying the work condition as a condition in which the machine 16 operated in accordance with an instruction of the worker, and the operation condition as a condition in which the machine 16 operated in accordance with the program.

Since the output unit 10 displays the data for specifying the work condition and the operation condition, the manager of the machine 16 can know the condition in which the machine 16 operates in accordance with the program and the condition in which the machine 16 operates in the manual operation work. That is, with the work condition visualization apparatus 2, the manager of the machine 16 can know the condition in which the machine 16 operates in accordance with the program and the condition in which the machine 16 operates in the manual operation work.

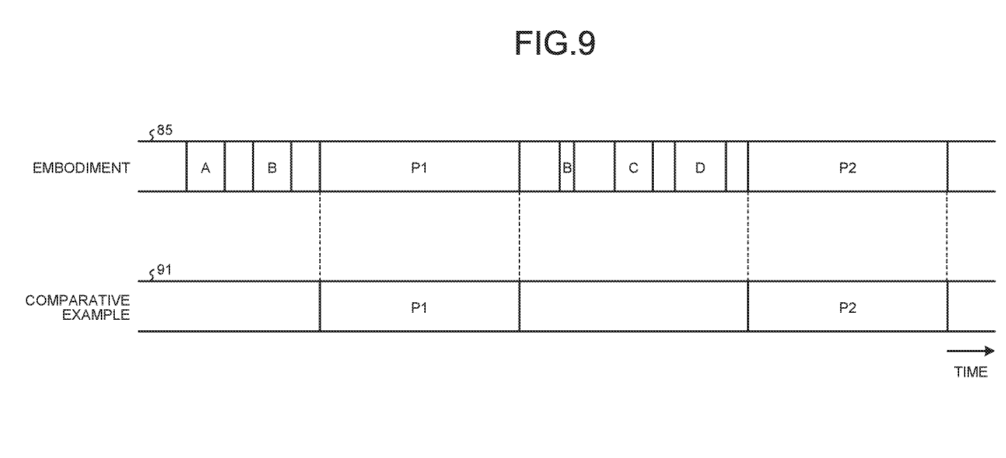

The effect of the work condition visualization apparatus 2 will be further described. FIG. 9 is a diagram for explaining the effect achieved by the work condition visualization apparatus 2 in the embodiment. The band 81 of the “embodiment” of FIG. 9 is the same as the band 81 of FIG. 8. A band 91 of a “comparative example” of FIG. 9 is obtained by deleting five blocks “A”, “B”, “B”, “C”, and “D” from the band 81 of FIG. 8. From the band 91 of the “comparative example” of FIG. 9, it is possible to know the condition in which the machine 16 operates in accordance with the program, but it is not possible to know the condition in which the machine 16 operates in the manual operation work. On the other hand, from the band 81 of the “embodiment” of FIG. 9, it is possible to know the condition in which the machine 16 operates in the manual operation work as well as the condition in which the machine 16 operates in accordance with the program.

That is, as described above, with the work condition visualization apparatus 2, the manager of the machine 16 can know the condition in which the machine 16 operates in accordance with the program and the condition in which the machine 16 operates in the manual operation work. In addition, as is apparent from the band 81 of each of FIG. 8 and the “embodiment” of FIG. 9, when displaying the condition in which the machine 16 operates in the manual operation work, the work condition visualization apparatus 2 displays the condition in which the machine 16 operates in the manual operation work for each of the multiple work items. Therefore, with the work condition visualization apparatus 2, the manager can know the condition in which the machine 16 operates in the manual operation work for each of the multiple work items.

Furthermore, as illustrated in the area above the band 81 of FIG. 8, the work condition visualization apparatus 2 displays the second data that specifies the total period of time for which the machine 16 operates in the manual operation work and the total period of time for which the machine 16 operates in accordance with the program. Therefore, the manager of the machine 16 can know the total period of time for which the machine 16 operates in the manual operation work and the total period of time for which the machine 16 operates in accordance with the program. More specifically, the work condition visualization apparatus 2 displays the total period of time for which the machine 16 operates in the manual operation work for each of the multiple work items. Therefore, the manager of the machine 16 can know the total period of time for which the machine 16 operates in work of manually operating the machine 16 for each of the multiple work items.

As described above, the output unit 10 transmits both of the first data and the second data to the accumulation device 17 outside the work condition visualization apparatus 2. The accumulation device 17 accumulates the data transmitted from the output unit 10 and permits access from an apparatus different from the work condition visualization apparatus 2. Therefore, even if the manager of the machine 16 cannot confirm the first data and the second data displayed by the output unit 10, the manager can acquire the first data and the second data by accessing the accumulation device 17 with the use of an apparatus that can access the accumulation device 17. That is, even if the manager cannot confirm the first data and the second data displayed by the output unit 10, the manager can confirm the first data and the second data by using the apparatus that can access the accumulation device 17. An example of the apparatus that can access the accumulation device 17 is a personal computer.

Since the manager of the machine 16 can confirm the first data and the second data, it is possible to analyze the time required for work of manually operating the machine 16, and to consider countermeasures for improving the efficiency of machining. In addition, the manager can consider better measures for improving the efficiency of machining by analyzing the first data and the second data for each of the multiple machines 16.

In the embodiment described above, the output unit 10 displays both of the first data and the second data, but the output unit 10 may display only one of the first data and the second data. As described above, the output unit 10 may output only one of the first data and the second data. The output unit 10 may transmit only one of the first data and the second data to the accumulation device 17. The first data may include information on the time when the machine 16 started an operation and information on the time when the machine 16 ended the operation for each of multiple types of work of manually operating the machine 16, and may include information on the time when the machine 16 started an operation in accordance with the program and information on the time when the machine 16 ended the operation.

In the embodiment described above, the input unit 5 is a touch panel display, but the input unit 5 is not limited to the touch panel display. The input unit 5 may be, for example, a constituent element constituted by a part or all of a mechanical button, a keyboard, and a mouse.

In the embodiment described above, the output unit 10 is a touch panel display that realizes the function of the input unit 5, but the output unit 10 may be a touch panel display different from the touch panel display that realizes the function of the input unit 5, or a display device other than the touch panel. When the output unit 10 is the display device, the output unit 10 displays one or both of the first data and the second data. The output unit 10 may be a printing device, and when the output unit 10 is the printing device, the output unit 10 prints one or both of the first data and the second data on a medium for printing. An example of the medium for printing is paper.

In the embodiment described above, the work condition visualization apparatus 2 includes the determination unit 6 that determines whether the machine 16 operates in the manual operation work or operates in accordance with the program on the basis of an instruction accepted by the input unit 5. The function of the determination unit 6 may be realized by a cloud outside the work condition visualization apparatus 2. When the function of the determination unit 6 is realized by the cloud outside the work condition visualization apparatus 2, the work condition visualization apparatus 2 may not include the determination unit 6, and may acquire a result which should be acquired by the determination unit 6 from the cloud.

The configurations described in the embodiment above are merely examples of the content of the present invention and can be combined with other known technology and part thereof can be omitted or modified without departing from the gist of the present invention.

### REFERENCE SIGNS LIST

1 numerical control apparatus; 2 work condition visualization apparatus; 3 control unit; 4 memory; 5 input unit; 6 determination unit; 7 timepiece; 8 storage unit; 9 management unit; 10 output unit; 16 machine; 17 accumulation device; 41 processing circuit; 46 memory; 47 processor.

1. A work condition visualization apparatus comprising:
an receiver to accept an input of an instruction to specify whether to operate a machine in manual operation work before and/or after the machine operates in accordance with a program or to operate the machine in accordance with the program; and
an display to display time information on the manual operation work and time information on the program on a basis of an instruction accepted by the receiver, wherein
the display displays, by a band, first data for determining a condition in which the machine operated in the manual operation work and a condition in which the machine operated in accordance with the program depending on passage of time.

2. (canceled)

3. The work condition visualization apparatus according to claim 1, further comprising a storage to store information on time when the machine operated in the manual operation work and information on time when the machine operated in accordance with the program on a basis of an instruction accepted by the receiver, wherein
the display displays time information on the manual operation work and time information on the program on a basis of information stored in the storage.

4. The work condition visualization apparatus according to claim 1, wherein
the receiver accepts an input of an instruction to specify that the machine is operated in the manual operation work for each of work items, and
the display displays the first data by the band, and second data for specifying a total period of time for which the machine operated in the manual operation work and a total period of time for which the machine operated in accordance with the program, for each of the work items.

5. (canceled)

6. The work condition visualization apparatus according to claim 3, wherein
the receiver accepts an input of an instruction to specify that the machine is operated in the manual operation work for each of work items, and
the display displays the first data by the band, and second data for specifying a total period of time for which the machine operated in the manual operation work and a total period of time for which the machine operated in accordance with the program, for each of the work items.
